(19) United States
(12) Patent Application Publication
(10) Pub. No.: US 2013/0064173 A1
(43) Pub. Date: Mar. 14, 2013

(54) RELAY NODE AND MOBILE TELECOMMUNICATIONS SYSTEM

(71) Applicants: Sivapathalingham Sivavakeesar, Bracknell Berkshire (GB); Hidekazu Tsuboi, Osaka-shi (JP); Katsunari Uemura, Osaka-shi (JP); Daiichiro Nakashima, Osaka-shi (JP)

(72) Inventors: Sivapathalingham Sivavakeesar, Bracknell Berkshire (GB); Hidekazu Tsuboi, Osaka-shi (JP); Katsunari Uemura, Osaka-shi (JP); Daiichiro Nakashima, Osaka-shi (JP)

(73) Assignee: SHARP KABUSHIKI KAISHA, Osaka-shi, Osaka (JP)

(21) Appl. No.: 13/643,315

(22) PCT Filed: Apr. 19, 2011
(86) PCT No.: PCT/JP2011/059998

§ 371 Date: Nov. 19, 2012

(30) Foreign Application Priority Data
Apr. 28, 2010 (GB) 1007093.6

(51) Int. Cl. H04W 40/00; H04B 7/14

(52) U.S. Cl. 370/315

(57) ABSTRACT

A relay node operable to maintain an access link to a UE and a backhaul link to a D-eNB, wherein each of access link and backhaul links are controlled by separate states. The separate states may be independent from one another. The backhaul link consists of at least two states: the first state and the second state of backhaul link. In the first state, a relay node monitors signals from D-eNB continuously. In the second state, a relay node monitors signal from D-eNB discontinuously. The access link consists of at least two states: the first state and the second state of access link. In the first state, a relay node transmits common control signals. In the second state, a relay node can pause the transmission of common control signals or transmit common control signals in longer period than in the first state of access link (DTX).

### TECHNICAL FIELD

The present invention relates to a relay node (relay apparatus) and a mobile telecommunications system in which said relay and others are operable to function. Further, the present invention is desirably used in connection with the Long Term Evolution Advanced (LTE-A) standard for mobile network technology. The present invention is particularly adapted to use with type-1 relays, although it should be noted that it is not limited thereto.

### BACKGROUND ART

The increase of mobile data, together with an increase of mobile applications (such as streaming content, online gaming and television and internet browsers) has prompted work on the LTE standard. This has been superseded by the LTE-A standard.

LTE-A or LTE Advanced is currently being standardized by the 3GPP as an enhancement of LTE. LTE mobile communication systems are expected to be deployed from 2010 onwards as a natural evolution of GSM and UMTS.

Being defined as 3.9G (or 3G+) technology, LTE does not meet the requirements for 4G, also called IMT Advanced, as defined by the ITU/3GPP that has requirements such as peak data rates up to 1 Gbps.

To aid further understanding of the present invention, a brief disclosure of LTE and LTE-A architecture will now be provided in conjunction with FIG. 1. The radio access network in the LTE and LTE-A standard is generally termed Evolved Universal Terrestrial Radio Access Network (E-UTRAN). Certain types of E-UTRAN entities are termed eNode-Bs or eNBs, and others termed relays. In E-UTRAN, a base station is generally termed an eNB. Typically, one or more relay nodes will be controlled by an eNB. This controlling eNB is usually termed a donor eNB or D-eNB.

The network uses a new Packet Core—the Evolved Packet Core (EPC) network architecture to support the E-UTRAN.

The pertinent functional elements are discussed below.

Evolved Universal Terrestrial Radio Access Network (E-UTRAN)

The E-UTRAN for LTE consists of a single node, generally termed the eNB that interfaces with a given mobile phone (typically termed user equipment, or user terminal). For convenience, the term UE—user equipment—will be used hereafter. The eNB hosts the physical layer (PHY), Medium Access Control layer (MAC), Radio Link Control (RLC) layer, and Packet Data Control Protocol (PDCP) layer that include the functionality of user-plane header-compression and encryption. It also offers Radio Resource Control (RRC) functionality corresponding to the control plane. The eNB performs many functions including radio resource management, admission control, scheduling, enforcement of negotiated up-link QoS, cell information broadcast, ciphering/deciphering of user and control plane data, and compression/decompression of down-link/up-link user plane packet headers.

Serving Gateway (SGW)

The SGW routes and forwards user data packets. For idle mode UEs, the SGW terminates the downlink data path and triggers paging when downlink data arrives for the UE. It manages and stores UE contexts.

Mobility Management Entity (MME)

The MME is responsible for idle mode UE tracking and paging procedure including retransmissions. It is involved in the bearer activation/deactivation process and is also responsible for choosing the SGW for a UE at the initial attach and at time of intra-LTE handover involving Core Network (CN) node relocation. It is responsible for authenticating the user. The Non-Access Stratum (NAS) signalling terminates at the MME and it is also responsible for generation and allocation of temporary identities to UEs. It checks the authorization of the UE to camp on the service provider's Public Land Mobile Network (PLMN) and enforces UE roaming restrictions. The MME is the termination point in the network for ciphering/integrity protection for NAS signalling and handles the security key management.

Packet Data Network Gateway (PDN GW)

The packet data network gateway provides connectivity to the UE to external packet data networks by being the point of exit and entry of traffic for the UE. A UE may have simultaneous connectivity with more than one PDN GW for accessing multiple PDNs. The PDN GW performs policy enforcement, packet filtering for each user, charging support, lawful interception and packet screening.

The purpose of the LTE-A standard system is to allow for service providers to reduce the cost of providing a network by sharing E-UTRANs but each having separate core networks. This is enabled by allowing each E-UTRANs—such as an eNB—to be connected to multiple core networks. Thus, when a UE requests to be attached to a network, it does so by sending an identity of the appropriate service provider to the E-UTRAN.

LTE and LTE-A uses multiple access schemes on the air interface: Orthogonal Frequency Division Multiple Access (OFDMA) in downlink and Single Carrier Frequency Division Multiple Access (SC-FDMA) in uplink. Furthermore, MIMO antenna schemes form an essential part of LTE. E-UTRA employs two synchronisation channels—primary and secondary—for the UE air interface synchronisation.

The layer-1 (L1) and layer-2 (L2) protocols of the air interface terminate in the wireless device and in the eNB. The layer-2 protocols include the medium access control (MAC) protocol, the radio link control (RLC) protocol, and the packet data convergence protocol (PDCP). The layer-3 (L3) radio resource control (RRC) protocol also terminates in both the UE and the eNB. The protocols of the non-access stratum (NAS) in the control plane terminate in the UE and in the mobility management entity (MME) of the core network.

LTE employs the shared-channel principle, which provides multiple users with dynamic access to the air interface.

FIG. 2 shows the protocol layer architecture of a typical UE, eNB and mobility management entity. In the control-plane, the non-access stratum protocol, which runs between the MME and the UE, is used for control-purposes such as network attach, authentication, setting up of bearers, and mobility management. All NAS messages are ciphered and integrity protected by the MME and UE.

The RRC layer in the eNB makes handover decisions based on serving cell and neighbouring cell measurements sent by the UE, pages for the UEs over the air, broadcasts system information, controls UE measurement reporting such as the periodicity of Channel Quality Information (CQI) reports and allocates cell-level temporary identifiers to active UEs. It also executes transfer of UE context from the source eNB to the target eNB during handover, and does integrity protection of RRC messages. The RRC layer is responsible for the setting up and maintenance of radio bearers.

The PDCP layer is responsible for compressing/decompressing the headers of user plane IP packets.

The RLC layer is used to format and transport traffic between the UE and the eNB. The RLC layer also provides in-sequence delivery of Service Data Units (SDUs) to the upper layers and eliminates duplicate SDUs from being delivered to the upper layers. It may also segment the SDUs depending on the radio conditions.

Relaying has been identified as one of the key enabling technologies for LTE-A to improve the cell-edge performance. The use of relaying also allows improvements to system capacity. Because of the need to support high data rates, relay nodes may operate in small cells as a way to minimize unnecessary interference and improve soft/hard frequency re-use.

In LTE-A, relays are generally defined in two categories: type 1 and type 2. Type 1 relay nodes have their own PCI (Physical Cell ID) and are operable to transmit its common channel/signals. UEs receive scheduling information and HARQ feedback directly from the relay node. It is also possible for type 1 relay nodes to appear differently to eNBs to allow for further performance enhancement. Type 1 relays can be considered as containing the functionalities of both an eNB (control node) and UE (user equipment). Thus, in the backhaul link the relay node behaves like a UE (which is operated by the functionality of a UE), whereas in the access link it behaves like an eNB (which is operated by the functionality of an eNB). Or, put another way, the D-eNB sees the relay node as a UE, whereas the UE sees the relay node as an ordinary eNB.

US 2010/046418 A1 (Horn et. al, Published Feb. 25, 2010) deals with the relay architecture. As such, it proposes an apparatus, methodologies and computer programs that deal with the issue of how to establish communication with a relay via the backhaul, how to assign IP address to a relay and how to realise various tunneling to transmit the packets especially when the transport layer protocol and application layer protocol terminate at various nodes. However, this reference does not disclose having different state machines on the access link and backhaul link for the purpose of conserving energy and spectrum.

FIGS. 11-15 of this reference illustrate methodologies relating to providing relay functionality to extend coverage and/or increase throughput in wireless networks that could alternatively be represented as a series of interrelated states or events, such as in a state diagram.

However, this type of state is only in relation to generic relay architecture for the states being explained in relation to energy/spectrum saving.

Relay Technologies for WiMax and LTE-Advanced Mobile Systems (Yang Yang et. al—WiMAX update, IEEE Communications Magazine 2009) provides a general overview of different relay types that are applicable.

This reference discloses a centralized pairing approach where each relay proactively takes link measurements of each UE and sends the measurements to a D-eNB to make decisions as to how the pairing is to be realized.

However this reference does not relate to different state machines for the purpose of conserving energy and spectrum. Furthermore, it maintains a 1-to-1 restriction between a relay and a UE being served.

The present invention seeks to devise appropriate states and behaviours for relay nodes while taking into consideration their deployment scenarios and their inherent features as a way to improve their efficient operation in terms of their ability to minimise energy waste, to limit relay-induced interference and to conserve spectrum through enhanced soft/hard frequency reuse.

### SUMMARY OF INVENTION

According to the present invention there is provided a relay node operable to maintain an access link to a user equipment (UE) and a backhaul link to a D-eNB, wherein each of said access link and said backhaul link are controlled by separate states.

Another to another aspect of the present invention, there is provided a mobile telecommunications system. The mobile telecommunications system comprises a UE, a D-eNB, a plurality of relays associated with the D-eNB, wherein each of the D-eNB and the plurality of relays comprises respective cells within which they are able to support a wireless communication session with the UE, the cells being configured such that a first set of cells are located wholly within the cell of the D-eNB and a second set of cells configured to not be wholly contained in the cell of the D-eNB, the network configured to control the plurality of relays such that: relay nodes with cells in the first set are operable to have their access link reverted between an active state and an idle state, and relay nodes with cells in the second set are maintained such that their access link is permanently in an active state.

In order that the present invention be more readily understood, specific embodiments thereof will now be described with reference to the accompanying drawings.

### BRIEF DESCRIPTION OF DRAWINGS

FIG. 1 shows an embodiment of LTE-A architecture.

FIG. 2 shows the protocol layer architecture of a typical UE, eNB and MME.

FIG. 3 shows an example of the DRX mode.

FIG. 4 shows a representation of a mobile communications network.

FIG. 5 shows a representation of a relay wake-up signaling procedure.

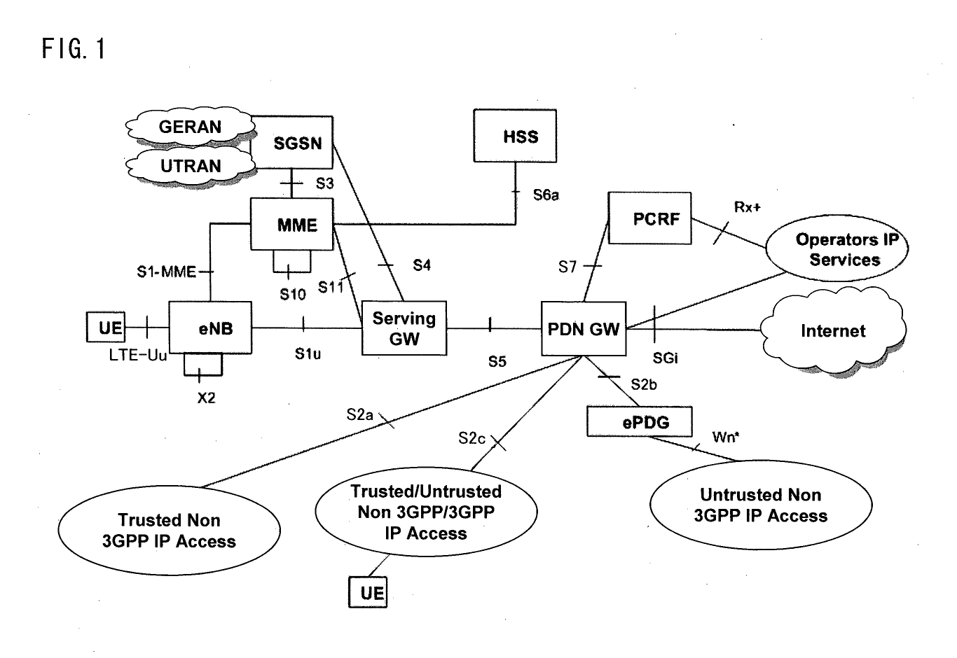

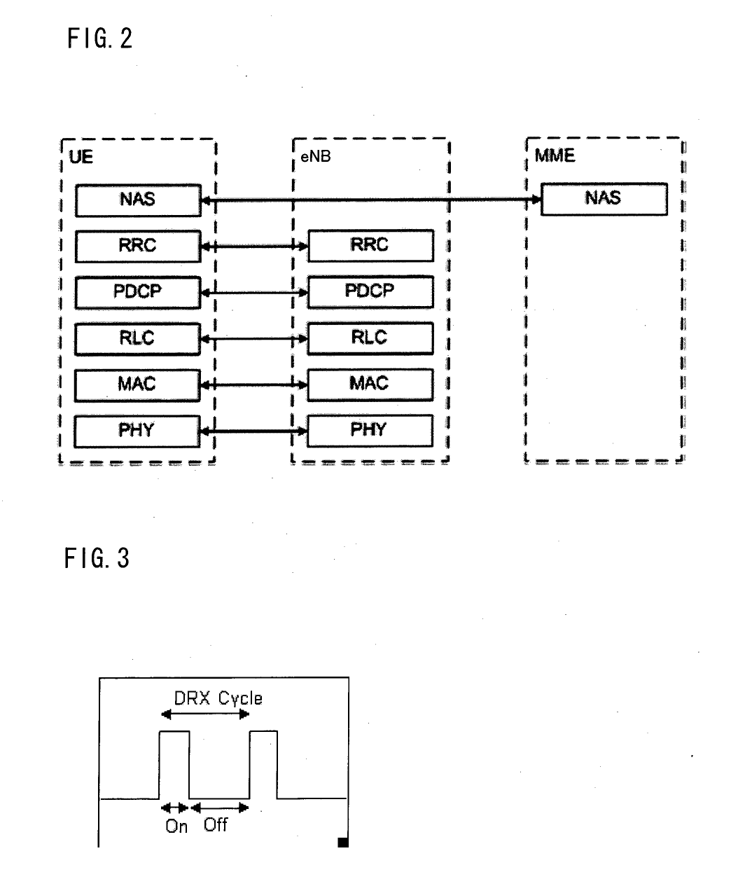

### DESCRIPTION OF EMBODIMENTS

The present invention refers to the following terms:

An user equipment is termed an UE.

A base station is termed an eNB.

An eNB which control a relay node is termed a donor eNB or D-eNB.

A link between a D-eNB and a relay node is termed a backhaul link or Un link.

A link between a relay node and an UE is termed an access link or Uu link.

A discontinuous reception is termed DRX.

A discontinuous transmission is termed DTX.

Relaying has been identified as one of the key enabling technologies for LTE-A to economically improve the cell-edge performance, system capacity and to extend the network coverage. To sufficiently achieve the desired goal, numerous relays need to be deployed. However, power consumption of each relay, as well as cell sites, is considerable, with radio networks normally accounting for around 80% of the total electricity used by an operator. As a result, there have been increased concern and statutory regulations going to be imposed on network operators to be energy-aware.

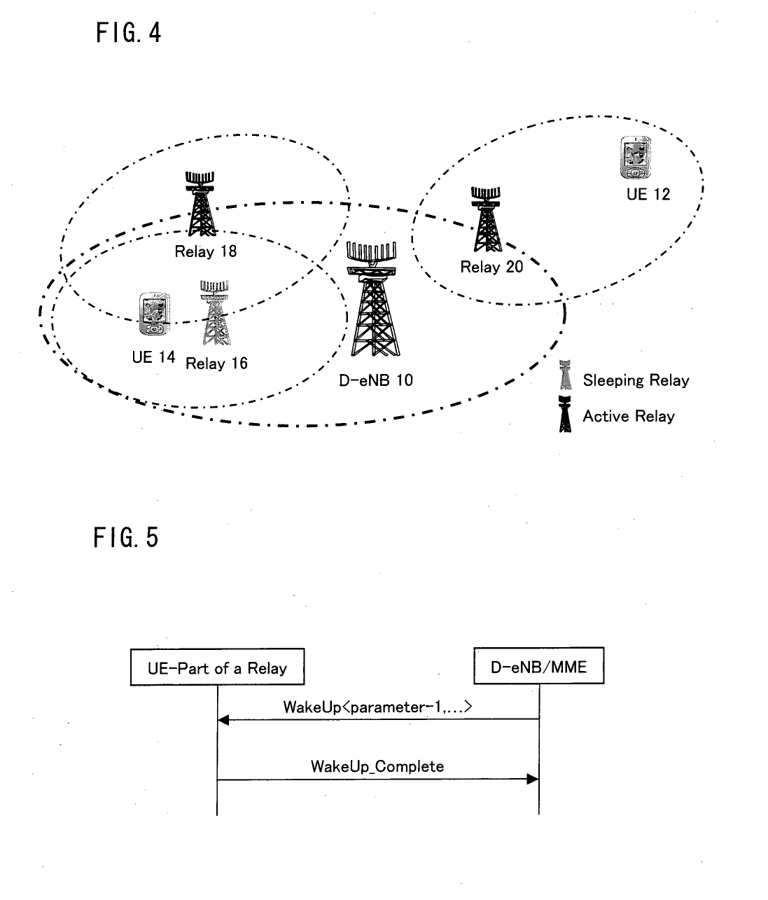

Relaying has been considered for LTE-A as an economical mechanism mainly to extend the network coverage to new areas and/or to increase the system capacity through systematic cell-splitting and better soft/hard frequency re-use. Although relaying has a potential to bring in other benefits such as facilitating group mobility, temporary network deployment, and improved cell-edge performance, it may be considered that, at least in the short term, relays are going to be used predominantly for extending network coverage (Scenario 1) or improving the system capacity (Scenario 2). This terminology will be used hereinafter. With reference to FIG. 4, relay 20 is used to extend the coverage of the network; UE 12 can only communicate with this relay. Relays 16 and 18 are examples of scenario 2: improving the system capacity.

Type 1 relays have the potential to be adopted within 3GPP as one of the first generation relay candidates. Because of the need to support high data rates (1 Gpbs), relays may operate in small cells as a way to minimise unnecessary interference and to improve soft/hard frequency re-use—thus enhancing system capacity. As a result high density relay deployment scenario is highly likely and thus relays in a given area may outnumber eNBs. Accordingly, any relay specification should be designed while giving due consideration to its efficient operation. Efficient operation may be taken to mean energy-aware (i.e., minimising energy wastage) and interference-aware (i.e., reduction of unnecessary interference) operation with an attempt to improve soft/hard frequency re-use.

Network operators may tend to deploy numerous relay nodes in a given service region to support potentially large data rate; e.g. the peak 1 Gbps DL rate as demanded by LTE-A. Also small cell operation may be preferred to improve the system capacity while improving the economical re-use of scarce expensive spectrum—similar to GSM cell-splitting. Companies and private customers may prefer deploying indoor relays in so called femtocell deployment given the potential bottleneck of ADSL (asymmetric digital subscriber line) backhaul. This deployment case is more likely in urban areas. Given the large number of relay deployment, in one extreme, high power consumption due to many small cells translates directly to high operator OPEX, interference and a significant environmental impact—all of which are now increasingly unacceptable. In the other extreme given the peak data rate requirement of LTE-A is extremely high, small relay size is one way to achieve very high mobile data throughput and capacity. One way to meet these mutually conflicting requirements is through on-and-off relaying.

A relay node differs from other E-UTRAN nodes—such as a UE or an eNB—as it has to maintain two wireless links simultaneously—i.e., both the access (Uu) and backhaul (Un) links. Thus, a relay node is operable to maintain an access link to a user equipment (UE) and a backhaul link to a D-eNB. Hence, some solutions that can be best applied to other E-UTRAN nodes may not bring in the same degree of benefits if applied directly to relays.

The efficient operation of a relay, to some extent, greatly depends on the relay state machine. A state machine or finite state machine, is a model of behavior composed of a finite number of states, transitions between those states, and actions. In relation to a relay, the state machine may be considered as referring to the different operating modes that the relay node may function in.

Further, a relay node operates differently on the access link and the backhaul link, and therefore the present embodiment treats them differently, at least from the perspectives of energy saving. In the present arrangement two different state machines are used for the access and backhaul links.

Efficient relay operation depends at least in part on the deployment scenario. In the deployment scenario where a relay node is deployed to extend the network coverage (Scenario 1), it is probable that the UEs served by a relay may not see any other E-UTRAN (eNB/RN) entity. Hence, relays have to be constantly ACTIVE (similar to RRC_CONNECTED state of a UE). It is therefore appropriate for the access link to have one state only—which is RRC_CONNECTED. However, the relay could use DTX and DRX on the access link and the backhaul link respectively to save resources while being in the RRC_CONNECTED state.

In scenario 2—which uses relays to improve system capacity—it is likely to have overlapping serving regions or cells. More importantly it is more likely that the serving cell of a relay is within the serving region of the respective D-eNB. Also, it is possible that adjacent relay cells overlap with each other. This is shown diagrammatically in FIG. 4. The cells of relays 16 and 18 are within the service region of the D-eNB 10 and overlap with each other. Thus UE 14 is able to communicate with any of D-eNB 10, relay 16 or relay 18. This deployment case is particularly likely in urban areas. Given that there exists a large number of relays operating small cells, it may not always be necessary to power them all continuously, if the cells are unattended. Accordingly, it would be desirable to switch off unused relays to minimise unnecessary cell interference, energy wastage and to conserve scarce spectrum. Hence, in the present arrangement a relay node can take two RRC States (or one RRC_CONNECTED state with DTX) on the access link (ie. “separate” states), whereas the backhaul can take Long_DRX while being in the RRC_CONNECTED state.

It is preferred that the backhaul link consists of at least two states: the first state of backhaul link and the second state of backhaul link. In the first state of backhaul link, a relay node monitors signals from D-eNB continuously. In other words, the first state of backhaul link may be termed non-DRX state of RRC_CONNECTED state. In the second state of backhaul link, a relay node does not monitor signal from D-eNB discontinuously. In other words, the second state of backhaul link may be termed DRX state of RRC_CONNECTED state. It is preferred that the access link consists of at least two states: the first state of access link and the second state of access link. In the first state of access link, a relay node transmits common control signals such as synchronisation signal, broadcast signal, reference signal and the like. In the second state of access link, a relay node can pause the transmission of common control signals or transmit common control signals in longer period than in the first state of access link (DTX). The first state of access link may be termed ACTIVE state. The second state of access link may be termed STANDBY/IDLE state. In a different embodiment, the second state of access link can be DTX while being in RRC_CONNECTED state.

When the access link is in the first state of access link, the relay node is operable to maintain link/serve one or a plurality of UEs. In the second state of access link the relay node has limited functionality in terms of supporting UEs.

DRX is a technique for battery saving of an E-UTRAN entity (for example, a relay node). While still being active (or in the RRC_CONNECTED state), during the Inactivity period of DRX the node does not maintain any radio reception and associated processing capability. The objective of this DRX technique is to allow the node to maintain its connection with low power consumption.

In addition to power saving, DRX enables the relay node to resumes its activity much quicker than the IDLE mode. As a result, less signaling is required to wake up a relay node which is in DRX mode. In order to enable such an operation, the D-eNB needs to maintain a full communication context (and associated memory resources) for each relay node which is in DRX mode.

FIG. 3 shows an example of the DRX state using DRX cycles being composed of “On” periods of time, during which the relay node will decode the signal from D-eNB, and “off” periods during which the relay node will not decode the signal and the relay node's receiver is turned off.

In the LTE system, there are two kind of DRX: short_DRX and long_DRX. The long_DRX can take longer “off” periods than short DRX.

In a specific embodiment, UE 14 is located within the coverage areas of Relay 16, Relay 18 and D-eNB 10. UE 14 is in an RRC_IDLE state and is located closer to sleeping Relay 16 than either Relay 18 or D-eNB 10. In this embodiment, suppose that UE 14 initiates a GBR traffic demanding around 500 Mbps. UE 14 has to camp initially on Relay 18 or D-eNB 10 and to send the Service Request via the camped on cell (as Relay 16 is sleeping already). On receiving the initial context setup request from the serving MME, the camped on cell will get to know the quality of service (QoS) requirement of traffic that UE 14 intends to initiate. If it is determined that the camped on cell cannot meet the QoS requirement, it can wake up the neighbouring relays and handover the traffic, provided the measurement reports indicate that the neighbouring relay 16 can better support the QoS as demanded by the traffic of UE 14 in question.

If a state machine of a UE is adopted for a relay, switching from RRC_CONNECTED to RRC_IDLE state requires an explicit command from the network under normal circumstances other than being triggered by an RLF. More saving is possible if a relay node is permitted by the network to switch to RRC_IDLE state (on the access link) unilaterally after noticing a certain period of inactivity. A timer may be used to determine the period of inactivity. Although explicit control can be preferred, it is also better to switch states based on a timeout for more efficiency on the access link—this in turn can trigger the backhaul to take its long_DRX, if needed.

The present embodiment is configured to treat the access link and backhaul link differently for the purpose of efficient operation (i.e., minimise energy wastage and interference and improve soft/hard frequency re-use) and to design an appropriate relay state machine for each link for improved network energy saving, interference control and conservation of radio resources.

In an alternative embodiment, it is possible to consider the relay node as a single entity and let it control the access and backhaul links in a coordinated way such that the backhaul link can take Long_DRX and the access link can take DTX whenever efficient operation is needed while the RN sticks to RRC_CONNECTED state all the time from the perspective of the network.

In terms of the functionalities expected, Type-1 Relay takes different roles both on the access and backhaul links—i.e., on the backhaul link it behaves like a UE (UE-part of a relay) whereas on the access link it behaves like an eNB (eNB-part of a relay). In order to enable efficient relay operation, it is important to realise such different roles of a relay and devise solutions separately. Given that the network should be able to readily communicate with a relay it is preferred that a relay should maintain constant connectivity with the network. From the perspective of RRC State machine the UE-part of any relay has to be in the RRC_CONNECTED state on the backhaul all the time. However, during a period of inactivity, the UE-part of the relay node can adopt Long_DRX to enable efficient operation. The appropriate value for DRX can be determined at the time of the relay attachment process or more dynamically depending on time-of-day, traffic pattern of a given area where the relay is deployed and the like. In the case of access link, the efficient operation depends, at least in part, on the relay deployment scenario.

In the arrangement of FIG. 4, Relay 20 is used to extend the coverage of the network. UE 12 cannot see D-eNB 10 or relays 16 and 18. Under such circumstances, the only serving relay node 20 has to be active all the time. The eNB-part of a relay in deployment Scenario-1 has a one-state state machine. Accordingly, the eNB-part has to be in RRC_CONNECTED state all the time. It is possible for it to adopt DTX on the access link with dynamically agreed DTX duration period to improve the relay's efficient operation.

When relays are used for the purpose of increasing the system capacity (i.e., Scenario 2 in FIG. 4) the state machine of the eNB-part of a relay can be in RRC_IDLE state to enable efficient operation. Within a given D-eNB region there may be many relays—some of which can be in their ACTIVE state (RRC_CONNECTED) and others can be in their STANDBY state (RRC_IDLE), depending on whether they are serving any UE traffic or not respectively. Sometimes the network may get a relay to be in the STANDBY mode to minimise interference or at the time of resource shortage.

Taking the arrangement shown in FIG. 4, Relay 16 is in its IDLE (i.e., Sleeping) state. Idle UE 14 can communicate with D-eNB 10 and Relay 18. If idling UE 14 initiates a Service Request, it will initially be handled by the neighbouring active nodes (D-eNB 10 or Relay 18). Given that initial camping on or session initiation does not demand significant data rate, they can be still handled by the further away nodes. However, to supporting the user traffic, Relay 16 can be turned on dynamically (i.e., on-demand) in case the node to which UE 14 currently camps on cannot support the required data as demanded by UE 14. Under such circumstances, the camped on base station (i.e., relay 18 or D-eNB 10) can wake up relay 16 and handover the traffic thereto, after taking the required measurements. This will be further described below.

In the case of Scenario-2, the present arrangement allows various functionalities on the access link of a relay to be dynamically turned on and off, depending on the traffic demand, current load, varying channel conditions and seasonal effect on the radio link. The functionalities that are subject to such deactivation/activation on the access link can be, for instance, certain transceiver functionalities such that the transmission of Synchronisation Signal/CH, Broadcast CH, reference signals or receiver functionalities such as the reception on RACH and associated MAC functionalities. This is because the network operator may not have enough radio and energy resources to continuously and unnecessarily run access links of a multitudes of relays (i.e., potentially thousands of relays because of the need to support 1 Gbps in LTE-A) while experiencing severe relay induced interferences. Hence, if it is determined that there is no UE in the relay's coverage area or there are no active sessions to support (i.e., all UEs within the relay coverage area are in their RRC_IDLE state), the eNB part of the relay can switch itself completely off after a predetermined time-out (T_{IDLE})—which in turn gives a signal to the UE-part to take Long_DRX. In addition, explicit notification to the same effect can come from the network for the purpose of ICIC, load-balancing purposes and the like as mentioned before. In order to make this decision, an RN (i.e., eNB-part or UE-part of the relay) can take periodic measurements at L1 or L2 level to see whether it currently supports any active session.

According to this arrangement, in deployment Scenario-2, it is desirable to let the backhaul link of a relay be in Long_DRX while getting the access link to switch to its IDLE/DTX State enabled through either implicit (timer-based) or explicit triggering mechanism (DRX mechanism) as discussed before.

Two of the three new signalling messages introduced in this patent originate from the respective D-eNBs/MMEs whereas one originates from a relay. Commands such as WakeUp and GoToSleep flow from the D-eNB/MME to a relay in question, whereas RelayGoingToSleep originates from a relay. The purpose and a brief description of each of such messages are given below:

i) WakeUp<parameter1, parameter2, . . . >—issued by the D-eNB/MME for the purpose of waking up only certain functionalities of a relay on the access link that is in its power-saving IDLE state as indicated by the parameters. It also disables the Long_DRX on the backhaul if one of the parameter set requires it to be active. FIG. 5 shows a representation of the process.

ii) GoToSleep<parameter1, parameter2, . . . >—this command will be issued to an active relay by a D-enB to switch its backhaul to a Long_DRX mode while turning off various functionalities on the access link as indicated by the parameters. Typically, this message is sent to an ACTIVE relay. However, it can be sent to a sleeping relay with new parameters in case new functionalities need to be switched off. For instance, if a relay node receives GoToSleep<parameters . . . > for the first time from the network (e.g., DeNB/MME), the relay node can deactivates the required functionalities (dynamically deactivate) on Un and/or on Uu for a certain amount of time (i.e., deactivation duration) as indicated by the set of parameters (list of parameters). While in the deactivation mode, if an RN receives subsequent GoToSleep command, the RN will extends its deactivation of the exact functionalities as indicated in the set of parameters

iii) RelayGoingToSleep<parameter1, parameter2, . . . >—issued unilaterally by a relay to the D-eNB/MME after an inactive timeout (say, T_{IDLE}) of a timer. The parameters indicate the functionalities that are going to be switched off on the access link along with the DRX period for the backhaul long_DRX.

It may be necessary to execute random access procedure to re-synchronize to D-eNB before sending a RelayGoingToSleep command if the RN has the possibility to lose the uplink synchronization.

A brief summary of two specific embodiments will now be described. In a mobile communication network, the D-eNB and the plurality of relays comprises respective cells within which they are able to support a wireless communication session with the UE. The cells of the relay nodes are configured such that a first set of cells are located wholly within the cell of the D-eNB and a second set of cells configured to not be wholly contained in the cell of the D-eNB.

Deployment Scenario I: To Extend the Network Coverage

Relays are deployed to extend the coverage. This is a more likely case in rural areas. In this case, it is highly probable that the UEs served by a relay may not see any other E-UTRAN entities, such as D-eNBs or relay nodes. Hence, relays have to be in the constant ACTIVE (i.e., RRC_CONNECTED) state. Thus, relay nodes in this scenario are configured such that their access link is permanently in an ACTIVE (i.e., RRC_CONNECTED) state. A desirable operating mode for this case is:

Relay backhaul: ACTIVE possibly with Long_DRX

Relay access: ACTIVE possibly with DTX

The duration of the DTX/DRX depends on a number of factors including the traffic demand, time of the day, location, network condition and the network operator's preference. The agreed DTX/DRX value can be indicated in one of the parameters passed around as part of the three new signalling messages such as GoToSleep, RelayGoingToSleep, and WakeUp discussed above.

In this scenario, the GoToSleep command should not turn off the Uu interface of the relay node; instead, an intermittent transmission technique is allowed by adopting DTX mode while the relay being in RRC_CONNECTED state. The appropriate DTX duration can be indicated in one of the parameters of GoToSleep command.

Deployment Scenario II: To Improve the System Capacity

Network operators may tend to deploy numerous relay nodes in a given service region to support potentially very magnificent data rate; e.g. the peak 1 Gbps DL rate as demanded by LTE-A. Also small cell operation may be preferred if the network operators are to improve the system capacity while improving the economical re-use of scarce expensive spectrum similar to GSM cell-splitting. Companies and private customers may prefer to deploy in-door relays given the potential bottleneck of ADSL backhaul. This deployment case is quite likely in urban areas. In this particular case, given there exist a large number of relays operating small cells, it is not always necessary to power them continuously if the cells are unattended. This is highly likely and hence, there is a need to switch off unused relays to minimise unnecessary cell interference, energy wastage and to conserve scarce spectrum. In this case it is more likely that a UE in a relay coverage area can see many other E-UTRAN entities, including the D-eNBs. Given that this is more likely, a sleeping relay can be woken up on demand either by the respective D-eNB or a peer active relay in the neighbourhood. A possible strategy for this case is the following:
Relay backhaul: RRC_CONNECTED possibly with Long_DRX
Relay access: STANDBY when not in use (switch-off various functionalities)
   Or
ACTIVE possibly with DTX

As mentioned earlier, number of factors including the traffic demand, time of the day, location, network condition and the network operator's preference governs the value of Long_DRX and DTX. The agreed Long_DRX and DTX values can be indicated in some of the parameters being passed between a relay node and the network as part of the three new signalling messages such as GoToSleep, RelayGoingToSleep, and WakeUp discussed above.

In this scenario, it is possible to turn off the Uu interface of the relay node in response to the GoToSleep message.

In these above scenarios, it is possible to use the GoToSleep command as another usage. The D-eNB may send a GoToSleep<parameters> in advance to just indicate the parameters for STANDBY. For example, in the scenario-1, the parameter indicates “Relay access: ACTIVE with DTX or ACTIVE without DTX”, and in the scenario-2, the parameter indicates “Relay access: switch-off some functionalities or ACTIVE with DTX or ACTIVE without DTX”. And if there are no downlink data for the relay node from the D-eNB during the predetermined time (or the D-eNB sends a “DRX command” (the command that makes the downlink of backhaul link DRX) to the relay node), the backhaul link of the relay node is reverted to DRX(Long_DRX), and the access link of the relay node reverts to a STANDBY state with the parameters of the GoToSleep command. If the relay node receives the (additional) GoToSleep<parameters> whilst in Long_DRX, this state will be maintained with the (additional) parameters. It is preferred that if the relay node receives another message (for example WakeUp<parameters>) whilst in Long_DRX, the backhaul link of the relay node will revert from Long_DRX to fully operational mode and the access link of the relay node reverts to ACTIVE state.

Although the best states for the two deployment scenarios from the perspectives of efficient relay operation are captured above, the following state combinations for the access and backhaul are also possible as well. This is realised by passing the appropriate parameter set of the three signalling messages such as GoToSleep, RelayGoingToSleep, and WakeUp discussed above.
Access in STANDBY whereas Backhaul in Long_DRX mode.
Access in STANDBY whereas Backhaul in no-Long_DRX mode.
Access in ACTIVE mode whereas Backhaul in Long_DRX mode.
Access in ACTIVE mode whereas Backhaul in no-Long_DRX mode.

It is preferred that relay nodes are reverted to the second state of access link on the access link and the second state of backhaul link (long_DRX) on the backhaul link where possible. However, it also preferred that the relay nodes can be easily reverted to a fully operational state. A D-eNB (or MME or any active neighbour relay node) may revert a relay node that is in the second state of access link on the access link and the second state of backhaul link (Long_DRX) on the backhaul using a WakeUp<parameters> command together with one or many parameters indicating exactly the functionalities that need to be activated. Specifically, the relay node may receive a WakeUp command in the form of an RRC or NAS message. After the relay node would receive a WakeUp command, the relay node may change the states of the access link and the backhaul link into the first state of access link and the first state of backhaul link.

It is preferred that the relay node includes a timer to monitor inactivity on at least the backhaul link. In a preferred embodiment, a relay node in the second state of backhaul link (Long_DRX) on the backhaul link and in the first state of access link (similar to RRC_CONNECTED state) on the access link, may be switched to the second state of access link on the access link on noting a period of inactivity on the backhaul. The length of said period of inactivity may be predetermined, and may vary depending upon factors such as the time of day, or the day of the week and may be signalled to a relay node from a D-eNB in advance. Such a mechanism has the advantage of saving power and conserving bandwidth.

It is preferred that a relay node according to the present invention is operable to dynamically de-activate various functionalities on the access link after receiving a GoToSleep<parameters> command from a D-eNB (or MME). The parameters in the command indicate the functionalities of the relay node that need to be deactivated for a given amount of time from the network. In the second state of access link a relay node can pause the transmission of common control signals. In addition, a relay node can deactivate receiver functionalities concerning the access link such as the reception on RACH and associated MAC functionalities. It is preferred that D-eNB may signal such commands depend on the traffic demand, current load, varying channel conditions and seasonal effect on the radio link.

In a preferred embodiment, the D-eNB may send a GoToSleep<parameters> in advance. This may occur if the D-eNB notices that the relay node is inactive. In this circumstance, the backhaul link of the relay node is reverted to the second state of backhaul link (Long_DRX), and the access link of the relay node is reverted to the second state of access link. If the relay node receives the (additional) GoToSleep<parameters> whilst already in Long_DRX, this state will be maintained. It is preferred that if the relay node receives another message (for example WakeUp<parameters>) whilst in Long_DRX, the relay node will revert from the second state of backhaul link (Long_DRX) to the first state of backhaul link (non-DRX, fully operational mode).

In an alternative embodiment, the D-eNB may send a GoToSleep<parameters> to the relay node in advance to just indicate the parameters. And if there are no downlink data for the relay node from the D-eNB during the predetermined time (or the D-eNB sends a “DRX command” (the command that makes the downlink of backhaul link DRX) to the relay node), the backhaul link of the relay node is reverted to the second state of backhaul link (Long_DRX), and the access link of the relay node is reverted to the second state of access link with the parameters of GoToSleep command. If the relay node receives the (additional) GoToSleep<parameters> whilst in Long_DRX, this state will be maintained with the (additional or new) parameters. It is preferred that if the relay node receives another message (for example WakeUp<parameters>) whilst in Long_DRX, the backhaul link of the relay node will be reverted from the second state of backhaul link (Long_DRX) to the first state of backhaul link (non-DRX, fully operational mode) and the access link of the relay node will be reverted to the first state of access link.

Also, if a relay node receives GoToSleep<parameters . . . > for the first time from D-eNB, the relay node can deactivate the functionalities on the backhaul link and/or turn off the required functionalities on the access link for a certain amount of time (i.e., deactivation duration) as indicated by the set of parameters. While in the deactivation mode, if a relay node receives subsequent GoToSleep command, the relay node will extend its deactivation of the exact functionalities as indicated in the set of parameters.

A RRC signalling message will be used between the D-eNB and a relay node for the above commands while suiting the underlying relay architecture.

Preferably, if a relay node detects a period of inactivity on the access link, it will de-activate various functionalities on the access link and notifying a D-eNB using a “RelayGoingToSleep<parameters>” command together with a list of parameters indicating the functionalities that are to be deactivated for a given amount of time. The period of inactively on the access link may vary depending upon the time or day of the week or current load.

A new RRC signalling message will be used between the D-eNB and a relay node for this purpose while suiting the underlying relay architecture.

It is also preferred that additional instructions governing the deactivation/activation of transceiver functionalities such that the transmission of Synchronisation Signal/CH, Broadcast CH, reference signals or receiver functionalities such as the reception on RACH and the associated MAC functionalities will be paused/resumed on the access link, depending on the status of the relay node.

It is also preferred that a relay node switch the state of the access link depending on the state of the backhaul link. If a relay node sets the state of backhaul link the second state of backhaul link (Long_DRX), a relay node autonomously switch the state of the access link to the second state of access link without any command from D-eNB. And then a relay node pauses the transmission of common control signals.

It should be noted that the above described embodiments are done so for understanding the present invention, and should not be used to limit the scope of the present application.

### INDUSTRIAL APPLICATION

The present arrangement is particularly relevant LTE-A, although its applicable for both WiMAX (both IEEE 802.16e and IEEE 802.20) and Long range WiFi.

1-12. (canceled)

13. A relay node operable to maintain an access link to a user equipment (UE) and a backhaul link to a D-eNB,
wherein said access link and said backhaul link are controlled by separate states,
wherein the state for the access link has two states: a first state of access link and a second state of access link, and
wherein the state for the backhaul link has two states: a first state of backhaul link and a second state of backhaul link, a relay node does not act a discontinuous reception (DRX) mechanism in the first state of backhaul link, and acts DRX mechanism in the second state of backhaul link.

14. A relay node according to claim 13, wherein when a relay node is in the first state of access link a relay node transmits common control signal, when a relay node is in the second state of access link a relay node pauses the transmission of common control signal.

15. A relay node according to claim 13, wherein when the backhaul link reverts to the second state of backhaul link, the access link reverts to the second state of access link.

16. A relay node according to claim 13, wherein when the access link reverts to the second state of access link, the backhaul link is triggered to switch to the discontinuous reception (DRX) mechanism.

17. A relay node according to claim 13, wherein when the access link reverts to the first state of access link, the backhaul link is caused to deactivate the discontinuous reception (DRX) mechanism.

18. A relay node according to claim 13, wherein the relay node includes a timer to monitor inactivity on at least the backhaul link.

19. A relay node according to claim 18, wherein the length of said period of inactivity is predetermined.

20. A relay node according to claim 13, wherein said relay node is operable to dynamically de-activate various functionalities on the access link after receiving a command from a D-eNB.

21. A relay node according to claim 18, wherein on detection of a period of inactivity on the access link, the relay node de-activates functionalities on the access link and notifies a D-eNB with a list of parameters indicating the functionalities that have been deactivated.

22. A mobile telecommunications system comprising:
a UE;
a D-eNB;
a plurality of relays associated with the D-eNB,
wherein each of the D-eNB and the plurality of relays comprises respective cells within which they are able to support a wireless communication session with the UE, said cells being configured such that a first set of cells are located wholly within the cell of the D-eNB and a second set of cells configured to not be wholly contained in the cell of the D-eNB, said network configured to control the plurality of relays such that:
relay nodes with cells in the first set are operable to have their access link reverted between an active state and an idle state; and
relay nodes with cells in the second set are maintained such that their access link is permanently in an active state,
wherein in case of cells in the first set, the UE is in a plurality of cells, and in a case of cells in the second set, the UE is in a single cell.
